(19) United States
(12) Patent Application Publication
(10) Pub. No.: US 2025/0373361 A1
(43) Pub. Date: Dec. 4, 2025

(54) TECHNIQUES FOR DISTRIBUTED AUTOENCODING IN A DISTRIBUTED WIRELESS COMMUNICATIONS SYSTEM

(71) Applicant: Lenovo (Singapore) Pte. Ltd., Singapore (SG)

(72) Inventor: Mahdi Barzegar Khalilsarai, Berlin (DE)

(21) Appl. No.: 18/677,626

(22) Filed: May 29, 2024

(51) Int. Cl. H04L 1/00

(52) U.S. Cl. CPC H04L 1/0033; H04L 1/0036

(57) ABSTRACT

Various aspects of the present disclosure relate to techniques for distributed autoencoding in a distributed multiple-input multiple-output (MIMO) system. An apparatus is configured to define a computation model comprising at least one encoder and at least one decoder. The at least one encoder is associated with at least one radio unit (RU) and the apparatus is connected to the at least one RU via a corresponding fronthaul channel. The apparatus is configured to transmit a set of one or more parameters associated with the at least one encoder. The apparatus is configured to receive signaling from the at least one RU that includes an encoded set of symbols that includes a quantity of uplink data symbols encoded based on the set of one or more parameters. The apparatus is configured to decode the encoded set of symbols and compute an estimate of the quantity of uplink data symbols.

### TECHNICAL FIELD

The present disclosure relates to wireless communications, and more specifically to techniques for encoding wireless communications in a wireless communication system.

### BACKGROUND

A wireless communications system may include one or multiple network communication devices, such as base stations (BSs), which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

In one embodiment, a network entity may be configured to define a computation model comprising at least one encoder and at least one decoder, wherein the at least one encoder is associated with at least one radio unit (RU) of a set of one or more RUs, and wherein the network entity is connected to each of the set of one or more RUs via a corresponding fronthaul channel. The network entity may be configured to transmit, to the set of one or more RUs, a set of one or more parameters associated with the at least one encoder. The network entity may be configured to receive signaling from each of the set of one or more RUs, wherein the signaling comprises an encoded set of symbols, wherein the encoded set of symbols comprises a quantity of uplink data symbols encoded based on the set of one or more parameters associated with the at least one encoder. The network entity may be configured to decode the encoded set of symbols that is received from each of the set of one or more RUs using the at least one decoder based on a set of one or more parameters associated with the at least one decoder. The network entity may be configured to compute an estimate of the quantity of uplink data symbols based on the decoded set of symbols.

In one embodiment, a network entity is configured to receive a set of one or more parameters corresponding to the at least one encoder. In one embodiment, the network entity is configured to receive an uplink signal comprising a set of uplink data symbols for one or more UE. In one embodiment, the network entity is configured to encode a quantity of uplink data symbols of the set of uplink data symbols using the at least one encoder and based on the set of one or more parameters corresponding to the at least one encoder. In one embodiment, the network entity is configured to transmit the encoded quantity of uplink data symbols to a central unit (CU) using a fronthaul channel between the network entity and the CU.

### BRIEF DESCRIPTION OF THE DRAWINGS

FIG. 1 illustrates an example of a wireless communications system in accordance with aspects of the present disclosure.

FIG. 2 illustrates an example of a distributed MIMO network, in accordance with aspects of the present disclosure.

FIG. 3 illustrates an example schematic of UL data detection in a distributed MIMO system, in accordance with aspects of the present disclosure.

FIG. 4 illustrates an example of an encoder, in accordance with aspects of the present disclosure.

FIG. 5 illustrates an example of a decoder, in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by a device in accordance with aspects of the present disclosure.

FIG. 10 illustrates a flowchart of a method performed by a device in accordance with aspects of the present disclosure.

### DETAILED DESCRIPTION

A wireless communications system, such as a Distributed MIMO (D-MIMO) system (also referred to as a Cell-Free (CF) system), includes a number of RUs (e.g., base stations, access points, or remote radio heads) within one or more geographic coverage areas. These RUs may be operable to or configured to coordinate with each other for transmitting and receiving packets, data, control information, or any combination thereof, to and from devices (e.g., UEs). The D-MIMO system may provide for a high channel diversity, high reliability, low outage probability, or any combination thereof, to devices within the one or more coverage area. Additionally, the D-MIMO system may support providing uniform service to devices within the one or more coverage area via power control. The above advantages may be achieved because of the distributed framework (e.g., layout) of RUs in the D-MIMO system and the coordination between the RUs, which may be facilitated (e.g., enabled, coordinated) via a CU. The RUs are each connected to the CU by a respective fronthaul link (also referred to as fronthaul channel), which carries packets, data, control information, or any combination thereof to and from the CU, to be coherently transmitted on downlink (DL) channels or received on uplink (UL) channels, e.g., to be transmitted over long distances with minimal interference. Additionally, the CU may support power control in the D-MIMO system by determining one or more transmit and receive power coefficients based on channel properties and control (e.g., maximize) one or more network utilities (e.g., features, operations, functions, etc.).

In some cases, coordination via fronthaul links may result in unwanted delays. In some MIMO systems or massive MIMO systems, baseband processing is performed at a single BS associated with one cell; whereas, in a D-MIMO system packets, data, control information, or any combination thereof is transmitted on two different channels, such as an access channel between UEs and RUs and a fronthaul channel between the RUs and the CU. This may cause additional delays in data exchange. In some cases, this issue is avoided by using high capacity fronthaul links, (e.g., optical fiber links, which provides virtually instantaneous fronthaul signaling). However, dense deployment of fiber links may not be feasible or cost-effective. In some cases, wireless fronthaul links, such as for FR1, FR2 (mmWave) or any combination thereof, may be a more practical, but they offer less link capacity. Thus, to make D-MIMO systems more practical, it may be desirable to reduce the amount of packets, data, control information, or any combination thereof exchanged over the fronthaul links. Controlling the amount of packets, data, control information, or any combination thereof may rely on strategic design of algorithms that can extract the most useful information that an RU has to transmit to and receive from a CU for reliable communication.

The subject matter described herein is directed to addressing UL data detection in a D-MIMO system with limited fronthaul capacity. In UL, multiple UEs transmit data simultaneously to several RUs. Each RU computes a local estimate of the data by combining its received signal using an estimate of its channel to the UEs. The local estimates are source-encoded at each access point (AP) to compress their size, channel-encoded, and transmitted over their respective fronthaul links. The CU obtains encodings of local estimates, processes them jointly, and produces an estimate of the UL data. The encoding of local estimates at the RUs is strategically performed to meet the limited fronthaul capacity constraint per link, while reducing (e.g., minimizing) data detection error.

Some solutions suggest simple uniform scalar quantization of local estimates followed by an off-the-shelf channel coding, followed by linear combining of data at the CU. This can be improved to achieve lower fronthaul data rates via joint source and channel coding (JSCC). Suitable encoders (one per RU) and a decoder (at the CU) can be realized in a data-driven fashion by employing a learning model (e.g., a neural network (NN) model). The encoders are configured to compress local estimates while enabling channel-induced error correction and the decoder is tasked to jointly process all encoded signals and produce an estimate of the UL data. An advantage of this is that the optimized non-linear encoding/decoding enabled by a deep NN can achieve a lower symbol error rate for the same fronthaul link capacity (or lower fronthaul data rate for the same symbol error rate), as compared to a simple scalar quantization and linear decoding. This is enabled by the joint optimization of encoders and decoders, such that each RU sends a small portion of information about the UL data symbols to the CU, and the CU can combine such information from all the RUs to accurately detect the data due to its neural decoder.

Aspects of the present disclosure are described in the context of a wireless communications system.

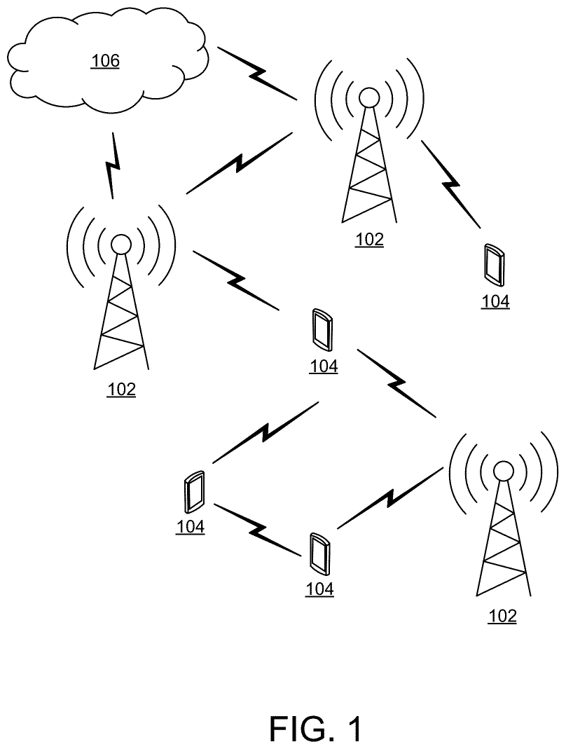

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmit-receive points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHZ), FR3 (7.125 GHZ-24.25 GHZ), FR4 (52.6 GHZ-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

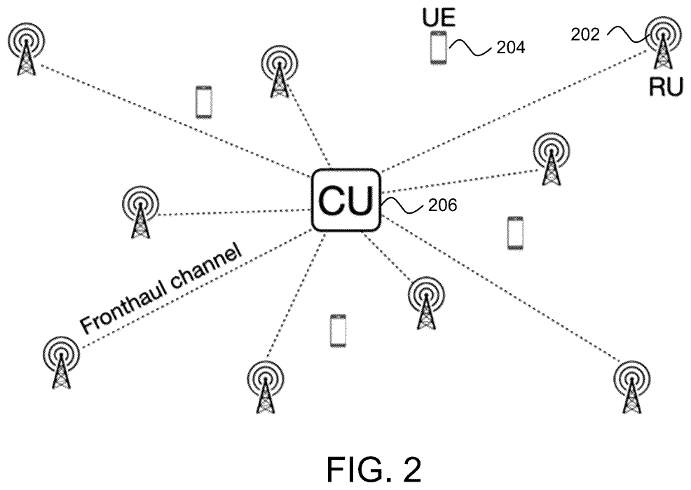

FIG. 2 illustrates an example of a distributed MIMO network, in accordance with aspects of the present disclosure. In the depicted scenario, a network with M RUs 202 and K scheduled single-antenna UEs 204 are presented, where each RU 202 is equipped with N receive antenna ports. It may be assumed that the RUs 202 are to be connected to a CU 206 for joint processing of data. In practice, the RUs 202 in the network may be clustered into groups, each being serviced by a single CU 206. Here, the focus is on the UL data processing of a single group.

UL data are transmitted simultaneously from the UEs to the RUs first over the access channel (the channel between UEs and RUs) and is then forwarded to the CU over the fronthaul channel (channel between RUs and the CU) for signal detection. The received baseband signal at RU m is a vector yₘ of dimension N expressed as

$$\begin{matrix}{y}_{m} = {\sum }_{k = 1}^{K} \sqrt{{p}_{k}} {h}_{k , m} {s}_{k} + {z}_{m} \\ = {H}_{m} {P}^{\frac{1}{2}} s + {z}_{m}\end{matrix} \qquad ( 1 )$$

Where h_{k,m} denotes the N-dimensional channel frequency response between AP m and UE k, sₖ∈ [symbol] is the data symbol of UE k that belongs to a set of constellation points [symbol] which satisfies [symbol] [|sₖ|²] 1 for all k, pₖ>0 is the normalized data transmission power of UE k and zₘ is the additive complex white Gaussian noise with i.i.d [symbol] (0,1) elements. The set of constellation points can be for example a QAM constellation of any order such as 16-QAM, 32-QAM, 64-QAM, etc. In the expression above, Hₘ=[h_{1,m}> . . . , h_{K,m}] is the channel matrix between the UEs and RU m, P=diag(p₁, . . . , p_{K}) is a diagonal matrix containing UE transmit powers, and s=[s₁, . . . , s_{K}]^{T} is the vector of Uplink data symbols. As a standard assumption, we model Hₘ as a random process that evolves according to a block-fading model in which it is constant over one coherence block of size and independent from one coherence block to another. In addition to data symbols, each RU also receives a set of reference signals that are used to estimate its respective channel to the UEs (i.e. Hₘ).

There are various strategies to share data with the CU:

(1) Compress-forward-estimate (CFE): Each RU compresses its received data signal as well as reference signals and sends them to the CU. The CU performs channel estimation and data detection.

(2) Estimate-compress-forward (ECF): Each RU first estimates its channel. Then it compresses the channel estimates and the data signal and sends them to the CU. The CU uses compressed channel estimates for data detection.

(3) Estimate-multiply-compress-forward (EMCF): Each RU estimates its channel, computes a local estimate of UL symbols by combining the received data signal using a receiver that is based on the channel estimate, compresses the local estimate and sends it to the CU which only performs data detection.

The last approach (EMCF) induces the smallest fronthaul overhead and it has been shown to yield very good performance (see, e.g., H. a. E. M. J. Masoumi, “Performance analysis of cell-free massive MIMO system with limited fronthaul capacity and hardware impairments,” IEEE Transactions on Wireless Communications, vol. 19, pp. 1038-1053, 2019, incorporated herein by reference). However, it is noted that the proposed methodology can be applied to the other strategies with certain modifications.

In EMCF, RU m computes an estimate of the UL data from yₘ using a receiver. To keep the processing cost at each RU low, it is standard to consider only linear receivers, represented by a matrix Rₘ of dimension K×N. Applying the receiver to the UL received signal above yields

$${\tilde{s}}_{m} = {R}_{m} {y}_{m} . \qquad ( 2 )$$

\tilde{s}ₘ is the local estimate of Uplink data at RU m, which is a vector of dimension K (one symbol per UE). The receiver Rₘ is designed based on an estimate of the UL channel between the UEs and RU m. This estimate, denoted by Ĥₘ is acquired by each RU separately using UL reference signals such as SRS. It can be computed as an MMSE estimate of the channel given reference signals and given pre-computed channel statistics, or in the absence of knowledge of channel statistics, using a least squares estimator. The receiver Rₘ is computed based on the estimate Ĥₘ, in various ways:

As a first example, a matched-filtering receiver is employed which is given as

$${R}_{m} = {P}^{- \frac{1}{2}} {D}_{m}^{- 1} {\hat{H}}_{m}^{H}$$

where Dₘ=diag(∥ĥ_{1,m}∥², . . . , ∥ĥ_{K,m}∥²) normalizes the rows of

$${\hat{H}}_{m}^{H} .$$

The matched-filtering receiver maximizes the received SNR at each RU.

In a second example, a zero-forcing receiver is employed which is given as

$${R}_{m} = {( {\hat{H}}_{m} {P}^{\frac{1}{2}} )}^{†}$$

Where (·)^{†} denotes Moore-Penrose pseudo-inverse. The zero-forcing receiver eliminates inter-user interference.

In a third example, a linear MMSE (L-MMSE) receiver is employed, which depends not only on the channel estimate but also on the spatial channel covariance matrix. An expression for Rₘ of the L-MMSE receiver is given in, e.g., Ö. T. a. B. E. a. S. L. a. o. Demir, “Foundations of user-centric cell-free massive MIMO,” Foundations and Trends {\textregistered} in Signal Processing, vol. 14, pp. 162-472, 2021, incorporated herein by reference. The L-MMSE receiver suppresses both noise and interference and yields the lowest expected mean-squared error between \tilde{s}ₘ and s.

From (1) and (2), the relation between the UL data vector and its local estimate at RU m is given by

$${\tilde{s}}_{m} = {G}_{m} s + {\tilde{z}}_{m} \qquad ( 3 )$$

re

$${G}_{m} = {R}_{m} {H}_{m} {P}_{m}^{\frac{1}{2}}$$

and \tilde{z}ₘ=Rₘzₘ. Therefore local estimates are “corrupted” observations of s. The process of this corruption can be uniquely characterized by a conditional probability density function p(\tilde{s}ₘ|s), which itself is a function of the channel and noise distributions. This is called the “effective” access channel. After obtaining local estimates, each RU compresses its own local estimates and sends its fronthaul channel to the CU.

The input of fronthaul channel m is represented by a generic complex-valued vector xₘ of dimension Lₘ which is computed based on \tilde{s}ₘ, and we represent the fronthaul channel m by a conditional density p(uₘ|xₘ) where uₘ is the channel output. This channel has a capacity of Cₘ bits per channel use. Most works on distributed MIMO, especially at the beginning of the time when they were proposed in works such as, e.g., H. Q. a. A. A. a. Y. H. a. L. E. G. a. M. T. L. Ngo, “Cell-free massive MIMO versus small cells,” IEEE Transactions on Wireless Communications, vol. 16, pp. 1834-1850, 2017, incorporated herein by reference, considered the fronthaul channel to have infinite capacity. This is a valid assumption when fronthaul links are implemented high bandwidth optical fiber with their very high capacity. However, it is important to make distributed MIMO networks compatible with limited-capacity fronthaul, as would be the case when the fronthaul is implemented via wireless. In that scenario, the capacity of each link might be variable and very low, which then requires compression of local estimates followed by channel error correction coding. The channel itself can have various forms. One example is the Gaussian vector channel where

$${u}_{m} = {x}_{m} + {n}_{m}$$

where nₘ˜ [symbol] (0, I_{L}_{ₘ}) is a Gaussian additive noise vector and the conditional density is given by p(uₘ|xₘ)˜ [symbol] (xₘ, I_{L}_{ₘ}). In this case, fronthaul channel capacity Cₘ is determined by the input power constraint ρₘ as (see e.g., B. a. C. B. Rassouli, “On the capacity of vector Gaussian channels with bounded inputs,” IEEE Transactions on Information Theory, vol. 62, pp. 6884-6903, 2016, incorporated herein by reference)

$${C}_{m} = {L}_{m} log ( 1 + \frac{{ρ}_{m}}{{L}_{m}} ) .$$

The CU combines the signals uₘ, m=1, . . . , M received via fronthaul links to compute an estimate s of the UL data symbol vector. This combination can be done in various ways, the simplest of which is to linearly combine them. The coefficients of the linear combination can be determined based on channel large scale fading coefficients between the UEs and the RUs to maximize received signal to noise ratio (SINR) (among all linear receivers), e.g., as analyzed in Ö. T. a. B. E. a. S. L. a. o. Demir, “Foundations of user-centric cell-free massive MIMO,” Foundations and Trends{\textregistered} in Signal Processing, vol. 14, pp. 162-472, 2021. If the data symbols belong to a discrete constellation, then each “soft” estimate of a symbol can be mapped to its nearest symbol in the constellation for the final estimate.

Here, the problem is to find functions that map \tilde{s}ₘ to uₘ and map uₘ, m=1, . . . , M to ŝ such that the expected distortion between s and ŝ is minimized. Such functions depend on the distributions of effective access channels and the fronthaul channels. The purpose of the mappings from \tilde{s}ₘ to uₘ is to compress data and make it resilient to the fronthaul channel distortion and the purpose of the mapping from uₘ, m=1, . . . , M to ŝ is to extract data from messages received from each RU at the CU.

Existing solutions for distributed MIMO with limited fronthaul capacity propose a two-step method of achieving this: (1) quantizing the local symbol estimates at each RU, and (2) apply a channel code to the bit sequence representing the quantization codeword. Furthermore, the problem of channel coding in the second step is avoided altogether by assuming that an ideal channel code can be applied to the compressed fronthaul message. As for quantization techniques, most research is limited to proposing and analyzing uniform scalar quantizers, which are applied separately to real and imaginary components of each dimension of the local estimate vector \tilde{s}ₘ.

For example, in M. a. N. H. Q. a. C. K. a. B. A. G. a. X. P. a. B. E. a. L. E. G. Bashar, “Uplink spectral and energy efficiency of cell-free massive MIMO with optimal uniform quantization,” IEEE Transactions on Communications, vol. 69, pp. 223-245, 2020, incorporated herein by reference, the authors propose the use of optimal uniform scalar quantizers for the compression of fronthaul data. Detection at the CU is achieved by simple aggregation of received codewords. In this case, the fronthaul message of each RU is represented by a codeword Q(\tilde{s}ₘ) where Q(·) is the element-wise scalar quantizer. These codewords are considered to be sent to the CU via ideal channel codes for each m. The final estimate of the UL symbols is then given by a linear combination of Q(\tilde{s}ₘ), m=1, . . . , M. An achievable rate expression is computed for this model by using the Bussgang decomposition to model quantization noise.

Another way of modeling quantization noise is proposed in T. a. H. J. O′shea, “An introduction to deep learning for the physical layer,” IEEE Transactions on Cognitive Communications and Networking, vol. 3, pp. 563-575, 2017, incorporated herein by reference, where the application of large-block lattice codes for quantization is assumed, which renders the quantization noise to be Gaussian. However, this work does not discuss any design for such codes and the research is limited to the analysis of achievable rates when such codes exist. In contrast, the subject matter herein is directed to the functional problem of quantization, fronthaul channel coding and centralized detection at the CU regardless of the analysis of achievable rates.

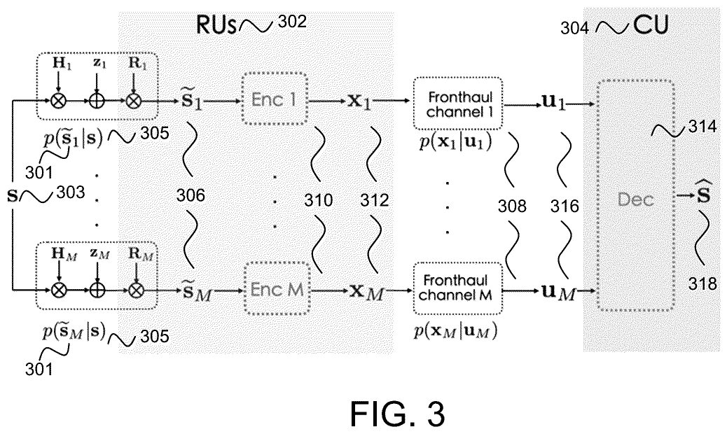

FIG. 3 illustrates an example schematic of UL data detection in a D-MIMO system, in accordance with aspects of the present disclosure. Considering the structure of UL data detection in a D-MIMO system, low error rates (in symbol estimation) can be achieved even with very limited fronthaul capacity by going beyond simple scalar quantization of local estimates at RUs 302 and linear combining of received fronthaul data at the CU 304. This is due to the number of RUs being potentially much larger than the number of scheduled UEs (at least this would be the desired D-MIMO scenario). Each RU 302 sends a “small amount” of information about its local estimate to the CU 304. By jointly processing all the data received by the RUs 302, the CU 304 will produce an estimate of the UL symbols vector. Scalar quantization and linear combining at the CU 304 do not fully exploit the potential of this distributed system. Here, solutions are proposed based on computation models, e.g., parametric learning models such as deep NNs that, when strategically designed, achieve small symbol detection errors with small amount of data exchanged over each fronthaul link. As used herein, a parametric learning model may refer to a learning model that simplifies a function (e.g., a cost function) to a known form by summarizing data with a set of parameters of fixed size (independent of the number of training examples).

In one embodiment, the UL data vector s 303 is an information source with some distribution p(s). Recalling Equation (3), this information source is observed by the M RUs 302 through the effective access channel represented by p(\tilde{s}ₘ|s) 305 for m=1, . . . , M. The random variables \tilde{s}ₘ 301 are corrupted versions of s and each of them are sources which are compressed and channel coded to be sent to the CU 304 via fronthaul links 308. To do this, a joint source and channel coding (JSCC) approach is applied, which simultaneously addresses compression of fronthaul messages and error correction coding by producing analog inputs to the fronthaul channel. Note the difference in comparison to separate source and channel coding where first the source is quantized and then it is channel coded.

Let ƒₘ: [symbol] ^{K}→ [symbol] ^{L}^{ₘ}, \tilde{s}ₘ→xₘ denote a deterministic function (e.g., a function that returns the same result given the same input values) that maps the local estimate \tilde{s}ₘ 306 to the fronthaul channel input. These are called the fronthaul encoders 310. The dimension of the fronthaul channel input is denoted with Lₘ for each link m=1, . . . , M and it is assumed that the channel input xₘ 312 should satisfy a power constraint as [symbol] [∥xₘ∥²]≤ρₘ where ρₘ>0 is a positive scalar. The fronthaul channel capacity depends on the power constraint ρₘ such that for any given capacity

$${C}_{m}^{⋆}$$

there is some

$${ρ}_{m}^{⋆}$$

that yields that capacity. Therefore, we will satisfy any given capacity constraint by enforcing the power constraint above for a corresponding value of ρₘ. For each m, the fronthaul channel converts xₘ to uₘ.

A joint decoder 314 g:

$${ℂ}^{L} \to {S}^{K} , u = {[ {u}_{1}^{T} , … , {u}_{M}^{T} ]}^{T} \to \hat{s}$$

where L=ΣₘLₘ maps the vector

$${[ {u}_{1}^{T} , … , {u}_{M}^{T} ]}^{T}$$

316 to an estimate of the UL data symbols vector ŝ 318. Distortion is defined as the expected deviation value or measure of discrepancy between the UL data symbols and their estimate D= [symbol] [d(s, ŝ)], where d(·, ·): [symbol] ^{K}× [symbol] ^{K}→ [symbol] ₊ denotes the distortion between the two vectors and the expectation is with respect to the data symbols, the effective access channels and the fronthaul channels.

If the functions ƒₘ, m=1, . . . , M and g are carefully designed, then the expected distortion will be low. In the ideal case, the expect distortion will reach the distortion-rate function of the model which is the smallest achievable expected distortion for any given set of fronthaul channel capacities C₁, . . . , C_{M}. Designing optimal encoders and the decoder is an extremely non-trivial problem, first because of the distributed nature of encoding and second because the statistics of channels and noise are not a priori known and even if they were known, closed-form derivation of the optimal vector quantizer would be hard to acquire.

It is proposed herein to implement the fronthaul encoders 310 and the joint decoder 314 as computation models, e.g., parametric learning models such as deep NNs with trainable parameters. In this regard, the fronthaul encoders 310 are functions ƒₘ(·; θₘ) parameterized by θₘ for m=1, . . . , M and the joint decoder 314 is a function g (·; φ) parameterized by φ. The NN is trained by optimizing the encoder/decoder parameters based on a dataset that consists of realizations of the data symbols, effective access channels, and the fronthaul channels. The model can be thought of as a distributed autoencoding system, where each fronthaul encoder 310 aims at compressing its local estimate and the joint decoder 314 maps the collective output of the fronthaul encoders 310 to an estimate of the original source. There are several advantages to implementing the system with NNs:

(1) The NNs are able to “learn” the best encoders/decoder with their high capacity of approximating a wide range of functions.

(2) Learning can be done efficiently using a dataset that is generated offline at the CU (as discussed below) and therefore they do not require explicit expressions for optimal encoding/decoding.

(3) At run-time, NNs are very fast since they consist of simple operations at each layer.

There are various ways of designing the architecture of the proposed NN-based JSCC distributed autoencoder. In the general case, each of the encoders and the decoder consist of input and output layers and multiple layers between them, where each layer consists of a number of neurons that represent a weighted combination of the neuron values in the previous layer followed by an activation function that introduces non-linearity.

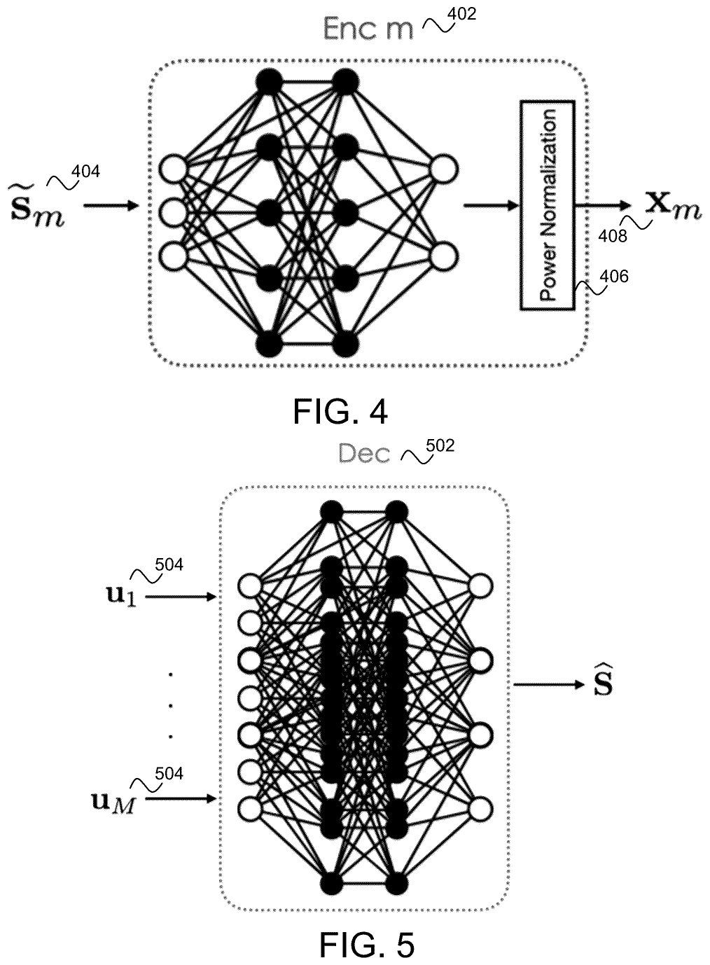

FIG. 4 illustrates an example of an encoder, in accordance with aspects of the present disclosure. In one example of NN design, a fully connected (FC) network for the encoders 402 is proposed. The input of encoder m 402 is a sample of the local estimate

$$\tilde{s} \begin{matrix}( t ) \\ m\end{matrix}$$

404, which is computed from one sample of the data vector s^{(t)} by sampling from the effective access channel conditional distribution p(\tilde{s}ₘ|s^{(t)}). The input vector can be represented with 2K real numbers. Then it is input to a network with J_{enc} hidden layers where each hidden layer has qⱼ neurons, j=1, . . . , J_{enc}. The output layer consists of 2 Lₘ neurons of real value, representing the Lₘ inputs to the fronthaul channel. To satisfy the fronthaul power constraint condition, a power normalization layer 406 is included at the output that normalizes the output vector to have squared norm equal to ρₘ.

FIG. 5 illustrates an example of a decoder, in accordance with aspects of the present disclosure. For the decoder 502, a similar FC implementation is used with multiple hidden layers. The input of the decoder is a sample of the vector u^{(t)} where each component

$${u}_{m}^{( t )}$$

504 is computed from one sample of the corresponding encoder output sample

$${x}_{m}^{( t )}$$

408 by sampling from the fronthaul channel conditional distribution

$$p ( {u}_{m} \vert {x}_{m}^{( t )} ) .$$

The shape of the output of the decoder depends on the defined distortion metric and the type of data symbols. Recall that the network is trained to minimize a cost function representing an expected distortion between s and ŝ, the result of which indicates a deviation value or other measure of discrepancy between the quantity of uplink data symbols and an output of the decoder. The deviation value may be based on a Hamming distance or a squared Euclidean distance between true uplink data symbols (the actual uplink data symbols) and estimated uplink data symbols. If, for example, the data symbols are generated from a continuous alphabet such as Gaussian, a suitable distortion measure is the squared error d(s, ŝ)=∥s−ŝ∥². In this case, the output pf the decoder network is of dimension 2K real numbers, representing the vector ŝ. However, if the symbols belong to a discrete alphabet such as a QAM constellation, then it is more appropriate to use the Hamming distance. The Hamming distance, for instance, represents symbol error rate:

$$d ( s , \hat{s} ) = {\sum }_{k = 1}^{K} 1 \{ {s}_{k} \neq {\hat{s}}_{k} \}$$

where 1{·} is the indicator function and the Hamming distance counts the number of symbols in which the estimated symbol does not match the true symbol. In this case, the symbols vector can be represented by a set of K one-hot vectors, each indicating the location of the corresponding symbol in the constellation set. This enables use of the softmax activation function with KL neurons in the output where softmax is applied separately to blocks of size L in the output layer. Then, the Hamming distance can be incorporated in the cost or loss function during training by using the cross-entropy loss between the one-hot vectors of the input and the output blocks.

Training of the NN model is performed at the CU, which may have access to the distribution of UL data symbols denoted by p(s), the distribution of access channels Hₘ, the distribution of noise in the access channels zₘ, and the conditional distribution p(uₘ|xₘ) representing each fronthaul link for m=1, . . . , M. Furthermore, the CU is aware of the transmit power of each UE, how the receiver matrix is computed at each RU as well as the fronthaul signaling power constraint at each RU, equivalent to the knowledge of the capacity of each fronthaul link.

In one embodiment, the knowledge of the data symbols distribution is justified by the fact that the data constellation is always known to the CU and the data of different UEs is independent from each other. In one embodiment, the distribution of access channels can be computed once by the RUs and sent to the CU, which then uses them for a time frame much longer than the coherence block since the distribution changes at a much slower rate than instantaneous channels.

In one embodiment, the distribution of additive noise depends on the power spectral density of thermal noise at the RUs, which can be easily estimated and shared with the CU. In one embodiment, the fronthaul channel statistics can be simply obtained at the CU, especially because both the CU and the RUs are fixed. In one embodiment, the fronthaul signaling power constraint at each RU can be simply shared with the CU. In one embodiment, the transmit power of each UE can also be shared with the CU and in fact is often determined by the CU itself to maximize network utility functions such as fairness.

With the knowledge of data, channel, and noise statistics as well as power coefficients, the CU can essentially train the distributed autoencoder NN offline by generating a dataset according to these distributions and parameters.

In one embodiment, the CU fixes a distortion measure d(s, ŝ) between the true and estimated data symbols. As mentioned before, the distortion measure can be, for example, the squared error d(s, ŝ)=∥s−ŝ∥² for continuous alphabets or the Hamming distance

$$d ( s , \hat{s} ) = {\sum }_{k = 1}^{K} 1 \{ {s}_{k} \neq {\hat{s}}_{k} \} .$$

It can also be other distance measures, for example the Hamming distance between individual bits representing each symbol.

In one embodiment, the CU generates a dataset of random samples

$$\{ ( {s}^{( t )} , {\{ {\tilde{s}}_{m}^{( t )} \}}_{m = 1}^{M} , {\{ {u}_{m}^{( t )} \}}_{m = 1}^{M} ) \sim p ( s , \tilde{s} , u ) = p ( s ) p ( \tilde{s} \vert s ) p ( u \vert \tilde{s} ) , t = 1 , … , {N}_{s} \} .$$

### Here

$$\tilde{s} = {[ {\tilde{s}}_{1}^{T} , … , {\tilde{s}}_{M}^{T} ]}^{T}$$

denotes the vector containing local estimates of all RUs, and

$$u = {[ {u}_{1}^{T} , … , {u}_{M}^{T} ]}^{T}$$

is the received fronthaul signals of all RUs at the CU. The conditional distribution p(\tilde{s}|s) is fully characterized by the distribution of access channels and noise. In addition, p(u|\tilde{s}) is characterized by the distribution of the fronthaul channels using the fact that the input of the fronthaul channel is a deterministic function (through encoders) of the local estimates. Having access to both, the CU can draw random samples of

$$( {s}^{( t )} , {\{ {\tilde{s}}_{m}^{( t )} \}}_{m = 1}^{M} , {\{ {u}_{m}^{( t )} \}}_{m = 1}^{M} )$$

of the UL data symbols, the local estimates and the fronthaul channel outputs.

In one embodiment, the CU computes an empirical mean of the distortion d(s, ŝ) using the dataset as a function of encoder/decoder parameters:

$$ℒ ( {θ}_{1} , … , {θ}_{M} , φ ) = \frac{1}{{N}_{s}} {\sum }_{t = 1}^{{N}_{s}} d ( {S}^{( t )} , {\hat{s}}^{( t )} )$$

$$where$$

$$\begin{matrix}{\hat{s}}^{( t )} = g ( {u}^{( t )} ; φ ) \\ {u}_{m}^{( t )} \sim p ( {u}_{m} \vert {x}_{m}^{( t )} ) , {x}_{m}^{( t )} = {f}_{m} ( {\tilde{s}}_{m}^{( t )} ; {θ}_{m} ) , m = 1 , … , M , \\ {\tilde{s}}_{m}^{( t )} \sim p ( {\tilde{s}}_{m} \vert {s}^{( t )} ) , m = 1 , … , M , \\ {s}^{( t )} \sim p ( s ) .\end{matrix}$$

In one embodiment, the CU solves the following optimization problem:

$$\begin{matrix}{minimize}_{{θ}_{1} , … , {θ}_{M} , φ} ℒ ( {θ}_{1} , … , {θ}_{M} , φ ) \\ subject to ‖ f\_m ( s\_m \hat{} ( ( t ) ) ; θ\_m ) ⊢ ⊣ ‖ \hat{} 2 \leq ρ\_m for m = 1 , … , M .\end{matrix}$$

to obtain optimal values of the parameters. The optimization can be carried out efficiently using back-propagation. The constraint in this optimization problem enforces the fronthaul power constraint and is automatically satisfied by the inclusion of the normalization layer at the output of the encoders as depicted in FIG. 4.

In one embodiment, after training, the CU sends the optimized parameters of each encoder

$${θ}_{m}^{★} , m = 1 , … , M$$

to its respective RU. The CU uses the optimized parameters φ* for the decoder. Once optimized, the parameters of encoders and decoder can be used for a long time since the channel statistics vary at a much lower rate than instantaneous channels. These parameters can be re-trained when channel statistics change.

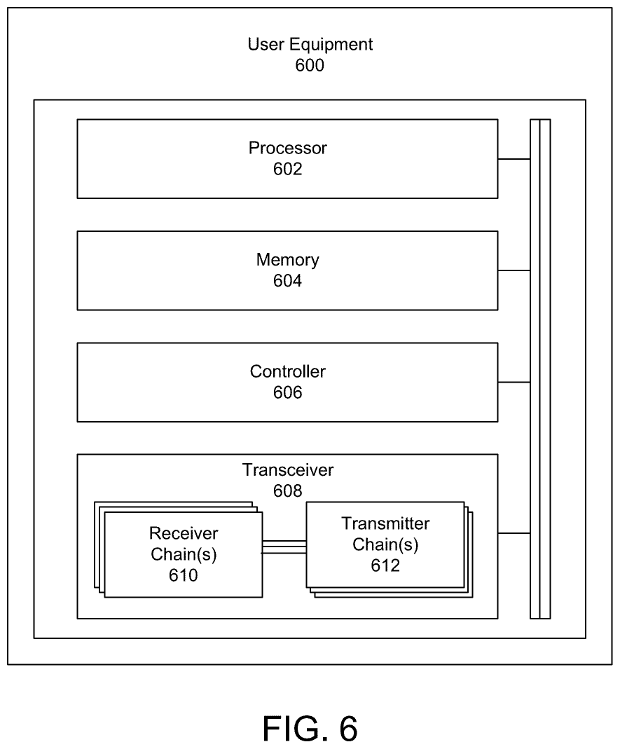

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or wireless medium. The receiver chain 610 may include at least one amplifier (e.g., a low-noise amplifier (LNA)) configured to amplify the received signal. The receiver chain 610 may include at least one demodulator configured to demodulate the received signal and obtain the transmitted data by reversing the modulation technique applied during transmission of the signal. The receiver chain 610 may include at least one decoder for decoding and processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

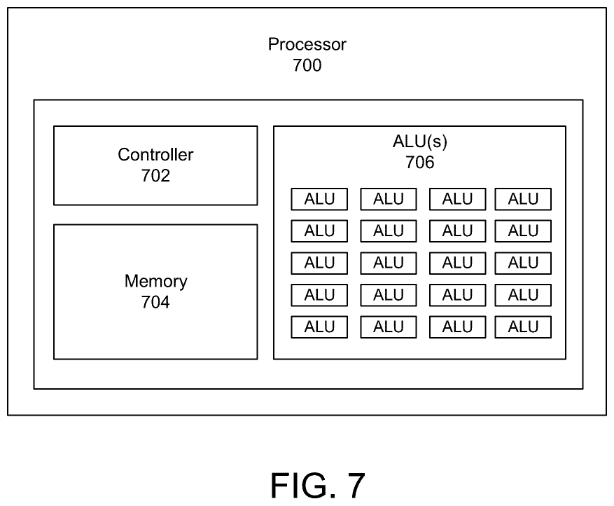

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. In one embodiment, the processor 700 may be configured to or operable to support a means to determine a NES mode for the NE, the NES mode comprising a DU-specific mode or an RU-specific mode of a distributed architecture, determine an NES class and an NES configuration for a traffic flow associated with the NE based on the NES mode, the NES class associated with a QoS class for the traffic flow, map the traffic flow to a DU, an RU, or a combination thereof based on the NES class associated with the traffic flow, and transmit the NES configuration to the DU, the RU, or the combination thereof mapped to the traffic flow.

The processor 700 may be configured to support a means to define a computation model comprising at least one encoder and at least one decoder, wherein the at least one encoder is associated with at least one RU of a set of one or more RUs, and wherein the network entity is connected to each of the set of one or more RUs via a corresponding fronthaul channel. The processor 700 may be configured to transmit, to the set of one or more RUs, a set of one or more parameters associated with the at least one encoder. The processor 700 may be configured to receive signaling from each of the set of one or more RUs, wherein the signaling comprises a set of symbols, wherein the set of symbols comprises an encoding of a quantity of uplink data symbols using the at least one encoder based on the set of one or more parameters associated with the at least one encoder. The processor 700 may be configured to decode the encoded set of symbols that is received from each of the set of one or more RUs using the at least one decoder based on a set of one or more parameters associated with the at least one decoder. The processor 700 may be configured to compute an estimate of the quantity of uplink data symbols based on the decoded set of symbols.

In one embodiment, the computation model comprises a parametric learning model. In one embodiment, the parametric learning model comprises a deep neural network.

In one embodiment, the processor 700 is configured to determine the set of one or more parameters of the at least one encoder or the at least one decoder by minimizing a cost function of model parameters.

In one embodiment, the processor 700 is configured to compute the cost function based on a dataset, wherein the dataset comprises a plurality of samples of the quantity of uplink data symbols, a plurality of samples of an uplink received signal associated with each of the set of one or more RUs, or a plurality of samples of received symbols from each of the set of one or more Rus.

In one embodiment, the dataset is generated at the network entity based on a statistical analysis of the quantity of uplink data symbols, a statistical analysis of access channels between a plurality of UE and the set of one or more RUs, or a statistical analysis of fronthaul channels.

In one embodiment, a result of the cost function indicates a deviation value between the quantity of uplink data symbols and an output of the at least one decoder. In one embodiment, the deviation value is based on a Hamming distance or a squared Euclidean distance between true uplink data symbols and estimated uplink data symbols. In one embodiment, the processor 700 comprises a CU, wherein the CU and the set of one or more RUs are connected in a distributed multiple-input multiple-output communication system via one or more fronthaul channels.

In one embodiment, the processor 700 is configured to receive a set of one or more parameters corresponding to the at least one encoder. In one embodiment, the processor 700 is configured to receive an uplink signal comprising a set of uplink data symbols for one or more UE. In one embodiment, the processor 700 is configured to encode a quantity of uplink data symbols of the set of uplink data symbols using the at least one encoder and based on the set of one or more parameters corresponding to the at least one encoder. In one embodiment, the processor 700 is configured to transmit the encoded quantity of uplink data symbols to a CU using a fronthaul channel between the network entity and the CU.

In one embodiment, the processor 700 is configured to determine the encoded quantity of uplink data symbols of the set of uplink data symbols based on one or more linear combinations of elements of the received uplink signal. In one embodiment, the encoded quantity of uplink data symbols of the set of uplink data symbols represents an estimate of uplink data symbols of the set of uplink data symbols.

In one embodiment, the processor 700 is configured to transmit the encoded quantity of uplink data symbols of the set of uplink data symbols to the CU as an analog signal. In one embodiment, the processor 700 is an RU of a set of one or more RUs that are connected to the CU in a distributed multiple-input multiple-output communication system via one or more fronthaul channels.

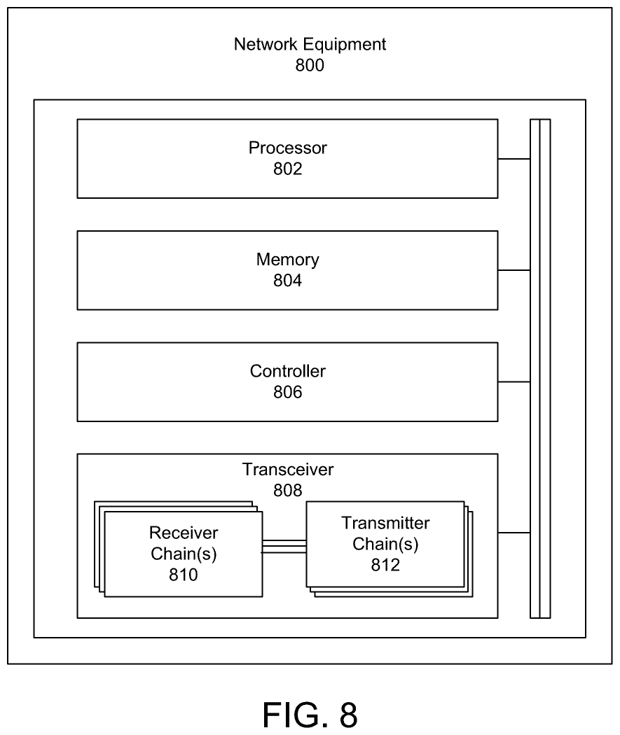

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The NE 800 may be configured to support a means to define a computation model comprising at least one encoder and at least one decoder, wherein the at least one encoder is associated with at least one RU of a set of one or more RUs, and wherein the network entity is connected to each of the set of one or more RUs via a corresponding fronthaul channel. The NE 800 may be configured to transmit, to the set of one or more RUs, a set of one or more parameters associated with the at least one encoder. The NE 800 may be configured to receive signaling from each of the set of one or more RUs, wherein the signaling comprises a set of symbols, wherein the set of symbols comprises an encoding of a quantity of uplink data symbols using the at least one encoder based on the set of one or more parameters associated with the at least one encoder. The NE 800 may be configured to decode the encoded set of symbols that is received from each of the set of one or more RUs using the at least one decoder based on a set of one or more parameters associated with the at least one decoder. The NE 800 may be configured to compute an estimate of the quantity of uplink data symbols based on the decoded set of symbols.

In one embodiment, the computation model comprises a parametric learning model. In one embodiment, the parametric learning model comprises a deep neural network.

In one embodiment, the NE 800 is configured to determine the set of one or more parameters of the at least one encoder or the at least one decoder by minimizing a cost function of model parameters.

In one embodiment, the NE 800 is configured to compute the cost function based on a dataset, wherein the dataset comprises a plurality of samples of the quantity of uplink data symbols, a plurality of samples of an uplink received signal associated with each of the set of one or more RUs, or a plurality of samples of received symbols from each of the set of one or more RUs.

In one embodiment, the dataset is generated at the network entity based on a statistical analysis of the quantity of uplink data symbols, a statistical analysis of access channels between a plurality of UE and the set of one or more RUs, or a statistical analysis of fronthaul channels.

In one embodiment, a result of the cost function indicates a deviation value between the quantity of uplink data symbols and an output of the at least one decoder. In one embodiment, the deviation value is based on a Hamming distance or a squared Euclidean distance between true uplink data symbols and estimated uplink data symbols. In one embodiment, the NE 800 comprises a CU, wherein the CU and the set of one or more RUs are connected in a distributed multiple-input multiple-output communication system via one or more fronthaul channels.

In one embodiment, the NE 800 is configured to receive a set of one or more parameters corresponding to the at least one encoder. In one embodiment, the NE 800 is configured to receive an uplink signal comprising a set of uplink data symbols for one or more UE. In one embodiment, the NE 800 is configured to encode a quantity of uplink data symbols of the set of uplink data symbols using the at least one encoder and based on the set of one or more parameters corresponding to the at least one encoder. In one embodiment, the NE 800 is configured to transmit the encoded quantity of uplink data symbols to a CU using a fronthaul channel between the network entity and the CU.

In one embodiment, the NE 800 is configured to determine the encoded quantity of uplink data symbols of the set of uplink data symbols based on one or more linear combinations of elements of the received uplink signal. In one embodiment, the encoded quantity of uplink data symbols of the set of uplink data symbols represents an estimate of uplink data symbols of the set of uplink data symbols.

In one embodiment, the NE 800 is configured to transmit the encoded quantity of uplink data symbols of the set of uplink data symbols to the CU as an analog signal. In one embodiment, the NE 800 is an RU of a set of one or more RUs that are connected to the CU in a distributed multiple-input multiple-output communication system via one or more fronthaul channels.

The memory 804 may include volatile or non-volatile memory. The memory 804 may store computer-readable, computer-executable code including instructions when executed by the processor 802 causes the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding and processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

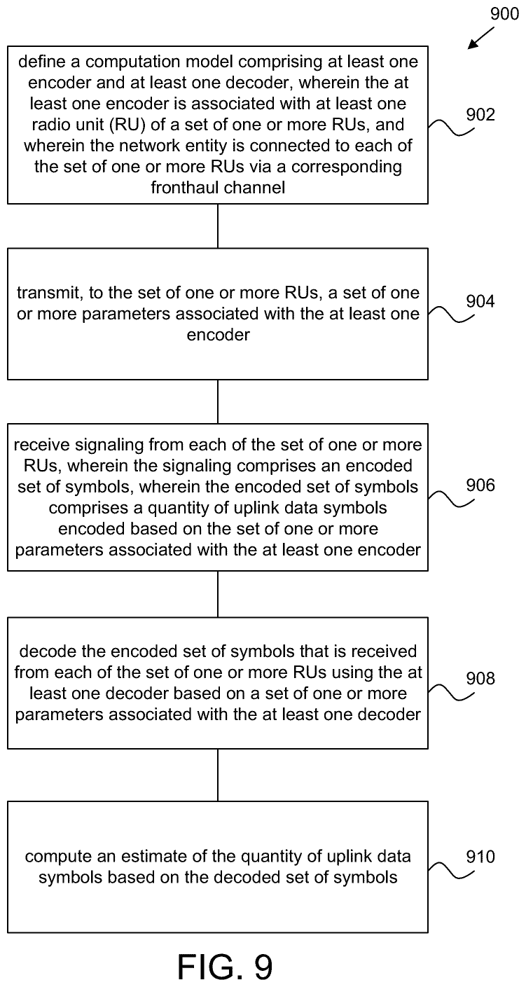

FIG. 9 illustrates a flowchart of a method in accordance with aspects of the present disclosure. The operations of the method may be implemented by an NE as described herein. In some implementations, the NE may execute a set of instructions to control the function elements of the NE to perform the described functions.

At 902, the method may define a computation model comprising at least one encoder and at least one decoder, wherein the at least one encoder is associated with at least one RU of a set of one or more RUs, and wherein the network entity is connected to each of the set of one or more RUs via a corresponding fronthaul channel. The operations of 902 may be performed in accordance with examples as described herein. In some implementations, aspects of the operations of 902 may be performed by the NE as described with reference to FIG. 8.

At 904, the method may transmit, to the set of one or more RUs, a set of one or more parameters associated with the at least one encoder. The operations of 904 may be performed in accordance with examples as described herein. In some implementations, aspects of the operations of 904 may be performed by the NE as described with reference to FIG. 8.

At 906, the method may receive signaling from each of the set of one or more RUs, wherein the signaling comprises an encoded set of symbols, wherein the encoded set of symbols comprises a quantity of uplink data symbols encoded based on the set of one or more parameters associated with the at least one encoder. The operations of 906 may be performed in accordance with examples as described herein. In some implementations, aspects of the operations of 906 may be performed by the NE as described with reference to FIG. 8.

At 908, the method may decode the encoded set of symbols that is received from each of the set of one or more RUs using the at least one decoder based on a set of one or more parameters associated with the at least one decoder. The operations of 908 may be performed in accordance with examples as described herein. In some implementations, aspects of the operations of 908 may be performed by the NE as described with reference to FIG. 8.

At 910, the method may compute an estimate of the quantity of uplink data symbols based on the decoded set of symbols. The operations of 910 may be performed in accordance with examples as described herein. In some implementations, aspects of the operations of 910 may be performed by the NE as described with reference to FIG. 8.

It should be noted that the method described herein describes a possible implementation, and that the operations and the steps may be rearranged or otherwise modified and that other implementations are possible.

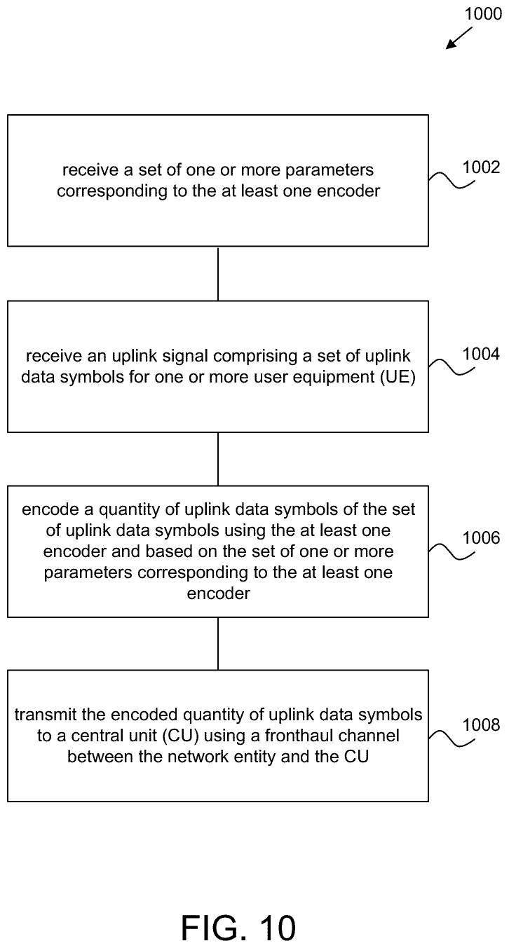

FIG. 10 illustrates a flowchart of a method in accordance with aspects of the present disclosure. The operations of the method may be implemented by an NE as described herein. In some implementations, the NE may execute a set of instructions to control the function elements of the NE to perform the described functions.

At 1002, the method may receive a set of one or more parameters corresponding to the at least one encoder. The operations of 1002 may be performed in accordance with examples as described herein. In some implementations, aspects of the operations of 1002 may be performed by the NE as described with reference to FIG. 8.

At 1004, the method may receive an uplink signal comprising a set of uplink data symbols for one or more UE. The operations of 1004 may be performed in accordance with examples as described herein. In some implementations, aspects of the operations of 1004 may be performed by the NE as described with reference to FIG. 8.

At 1006, the method may encode a quantity of uplink data symbols of the set of uplink data symbols using the at least one encoder and based on the set of one or more parameters corresponding to the at least one encoder. The operations of 1006 may be performed in accordance with examples as described herein. In some implementations, aspects of the operations of 1006 may be performed by the NE as described with reference to FIG. 8.

At 1008, the method may transmit the encoded quantity of uplink data symbols to a CU using a fronthaul channel between the network entity and the CU. The operations of 1008 may be performed in accordance with examples as described herein. In some implementations, aspects of the operations of 1008 may be performed by the NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one decoder;
at least one memory; and
at least one processor coupled with the at least one memory and configured to cause the network entity to:
define a computation model comprising at least one encoder and the at least one decoder, wherein the at least one encoder is associated with at least one radio unit (RU) of a set of one or more RUs, and wherein the network entity is connected to each of the set of one or more RUs via a corresponding fronthaul channel;
transmit, to the set of one or more RUs, a set of one or more parameters associated with the at least one encoder;
receive signaling from each of the set of one or more RUs, wherein the signaling comprises an encoded set of symbols, wherein the encoded set of symbols comprises a quantity of uplink data symbols encoded based on the set of one or more parameters associated with the at least one encoder;
decode the encoded set of symbols that is received from each of the set of one or more RUs using the at least one decoder based on a set of one or more parameters associated with the at least one decoder; and
compute an estimate of the quantity of uplink data symbols based on the decoded set of symbols.

2. The network entity of claim 1, wherein the computation model comprises a parametric learning model.

3. The network entity of claim 2, wherein the parametric learning model comprises a deep neural network.

4. The network entity of claim 1, wherein the at least one processor is configured to cause the network entity to determine the set of one or more parameters of the at least one encoder or the at least one decoder by minimizing a cost function associated with one or more parameters of the computation model.

5. The network entity of claim 4, wherein the at least one processor is configured to cause the network entity to compute the cost function based on a dataset, wherein the dataset comprises a plurality of samples of the quantity of uplink data symbols, a plurality of samples of an uplink received signal associated with each of the set of one or more RUs, or a plurality of samples of received symbols from each of the set of one or more RUs.

6. The network entity of claim 5, wherein the dataset is generated at the network entity based on a statistical analysis of the quantity of uplink data symbols, a statistical analysis of access channels between a plurality of user equipment (UE) and the set of one or more RUs, or a statistical analysis of fronthaul channels.

7. The network entity of claim 4, wherein a result of the cost function indicates a deviation value between the quantity of uplink data symbols and an output of the at least one decoder.

8. The network entity of claim 7, wherein the deviation value is based on a Hamming distance or a squared Euclidean distance between true uplink data symbols and estimated uplink data symbols.

9. The network entity of claim 1, wherein the network entity comprises a central unit (CU) and wherein the CU and the set of one or more RUs are connected in a distributed multiple-input multiple-output communication system via one or more fronthaul channels.

10. A processor for wireless communication, comprising:
at least one controller coupled with at least one memory and configured to cause the processor to:
define a computation model comprising at least one encoder and at least one decoder, wherein the at least one encoder is associated with at least one radio unit (RU) of a set of one or more RUs, and wherein the processor is connected to each of the set of one or more RUs via a corresponding fronthaul channel;
transmit, to the set of one or more RUs, a set of one or more parameters associated with the at least one encoder;
receive signaling from each of the set of one or more RUs, wherein the signaling comprises an encoded set of symbols, wherein the encoded set of symbols comprises a quantity of uplink data symbols encoded based on the set of one or more parameters associated with the at least one encoder;
decode the encoded set of symbols that is received from each of the set of one or more RUs using the at least one decoder based on a set of one or more parameters associated with the at least one decoder; and
compute an estimate of the quantity of uplink data symbols based on the decoded set of symbols.

11. The processor of claim 10, wherein the at least one controller is configured to cause the processor to determine the set of one or more parameters of the at least one encoder or the at least one decoder by minimizing a cost function associated with one or more parameters of the computation model.

12. The processor of claim 11, wherein the at least one controller is configured to cause the processor to compute the cost function based on a dataset, wherein the dataset comprises a plurality of samples of the quantity of uplink data symbols, a plurality of samples of an uplink received signal associated with each of the set of one or more RUs, or a plurality of samples of received symbols from each of the set of one or more RUs.

13. The processor of claim 12, wherein the dataset is generated based on a statistical analysis of the quantity of uplink data symbols, a statistical analysis of access channels between a plurality of user equipment (UE) and the set of one or more RUs, or a statistical analysis of fronthaul channels.

14. The processor of claim 11, wherein a result of the cost function indicates a deviation value between the quantity of uplink data symbols and an output of the at least one decoder.

15. A method performed by a network entity, the method comprising:
defining a computation model comprising at least one encoder and at least one decoder, wherein the at least one encoder is associated with at least one radio unit (RU) of a set of one or more RUs, and wherein the network entity is connected to each of the set of one or more RUs via a corresponding fronthaul channel;
transmitting, to the set of one or more RUs, a set of one or more parameters associated with the at least one encoder;
receiving signaling from each of the set of one or more RUs, wherein the signaling comprises an encoded set of symbols, wherein the encoded set of symbols comprises a quantity of uplink data symbols encoded based on the set of one or more parameters associated with the at least one encoder;
decoding the encoded set of symbols that is received from each of the set of one or more RUs using the at least one decoder based on a set of one or more parameters associated with the at least one decoder; and
computing an estimate of the quantity of uplink data symbols based on the decoded set of symbols.

16. A network entity for wireless communication, comprising:
at least one encoder;
at least one memory; and
at least one processor coupled with the at least one memory and configured to cause the network entity to:
receive a set of one or more parameters corresponding to the at least one encoder;
receive an uplink signal comprising a set of uplink data symbols for one or more user equipment (UE);
encode a quantity of uplink data symbols of the set of uplink data symbols using the at least one encoder and based on the set of one or more parameters corresponding to the at least one encoder; and
transmit the encoded quantity of uplink data symbols to a central unit (CU) using a fronthaul channel between the network entity and the CU.

17. The network entity of claim 16, wherein the at least one processor is configured to cause the network entity to determine the encoded quantity of uplink data symbols of the set of uplink data symbols based on one or more linear combinations of elements of the received uplink signal.

18. The network entity of claim 17, wherein the encoded quantity of uplink data symbols of the set of uplink data symbols represents an estimate of uplink data symbols of the set of uplink data symbols.

19. The network entity of claim 16, wherein the at least one processor is configured to cause the network entity to transmit the encoded quantity of uplink data symbols of the set of uplink data symbols to the CU as an analog signal.

20. The network entity of claim 16, wherein the network entity comprises a radio unit (RU) of a set of one or more RUs that are connected to the CU in a distributed multiple-input multiple-output communication system via one or more fronthaul channels.
